(19) United States
(12) Patent Application Publication
(10) Pub. No.: US 2004/0149848 A1
(43) Pub. Date: Aug. 5, 2004

(54) Reel and reel chucking structure

(75) Inventor: Hideaki Shiga, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/702,739

(22) Filed: Nov. 7, 2003

(30) Foreign Application Priority Data
Nov. 19, 2002 (JP) P2002-335323

(51) Int. Cl. G11B 23/107

(52) U.S. Cl. 242/340; 242/348

(57) ABSTRACT

A reel chucking structure comprises a rotation drive transmission part for transmission of rotation drive between a reel for winding a tape thereon and a spindle for driving and rotating the reel. The rotation drive transmission part is disposed in a plane extending substantially perpendicularly to a rotation axis. A projecting portion and a recessed portion for making the rotation axis of the reel coincide with the rotation axis of the spindle and projections and recesses for securing the spindle and reel in the rotation direction are disposed at different positions in the plane independently of each other.

### BACKGROUND OF THE INVENTION

1. Field of the Invention

The present invention relates to a reel and a reel chucking structure comprising a rotation drive transmission part for transmission of rotation drive between the reel for winding a tape thereon and a spindle for driving and rotating the reel.

2. Description of the Related Art

In the related art, as a magnetic tape cartridge used as a recording medium for use in an external storage apparatus such as a computer, for example, there is known a magnetic tape cartridge of a type in which a magnetic tape is wound around a single reel and the reel is rotatably stored in a cartridge case.

According to a magnetic tape cartridge 40 which is disclosed in JP-A-2002-83481, as shown in FIG. 4, a single reel 49 with a magnetic tape (not shown) wound thereon is rotatably stored in a cartridge case 47. The cartridge case 47 is composed of an upper case 43 and a lower case 45 having an opening 45a formed in the central portion thereof, while the upper and lower cases 43 and 45 are fastened together by a screw or the like. And, the magnetic tape cartridge 40 also includes reel rotation control unit 51 which allows the reel 49 to rotate when the magnetic tape cartridge 40 is in operation and restricts the rotation of the reel 49 when not in operation.

The reel 49 comprises a bottomed cylindrical-shaped reel hub 53 on the outer periphery of which the magnetic tape can be wound, and lower and upper flange portions 55 and 57 which respectively extend out in a disk-shaped manner in the radial direction from the outer peripheries of the lower and upper end portions of the reel hub 53. The reel hub 53 and lower flange portion 55 are formed as an integral body, and the upper flange portion 57 is connected to such integral body. The center-side lower portion of the reel hub 53 is closed by a bottom wall 53a. In the outer peripheral portion of the lower surface of the bottom wall 53a, there is cut formed a reel gear 63 in an ring manner, while the reel gear 63 can be meshingly engaged with a drive gear 61 included in rotation drive unit 59 on the drive mechanism side. Also, on the side of the bottom wall 53a that is nearer to the inner periphery thereof than the reel gear 63, there is mounted a reel plate 65 which is made of a ring-shaped metal plate for magnet-type attraction. And, the reel gear 63 and reel plate 65 of the reel 49 are respectively disposed in an opening 45a formed in the bottom surface of the cartridge case 47. By the way, the reel 49 is energized downwardly by an energizing member (a coil spring) 67.

On the other hand, the rotation drive unit 59 on the drive mechanism side comprises a ring-shaped drive gear 61 and a magnet (not shown) on the upper end face of a rotary shaft 69, while the chucking operation of the rotation drive unit 59 is carried out in the following manner: that is, the magnetic tape cartridge 40 mounted on a bucket (not shown) on the drive mechanism side is lowered down toward the rotary shaft 69, the drive gear 61 is meshingly engaged with the reel gear 63, and the reel plate 65 is attracted by the magnet, thereby maintaining such meshing engagement between the drive gear 61 and reel gear 63.

However, according to the above-mentioned magnetic tape reel chucking structure in the related art, the centering (alignment) of the reel and rotary shaft, the control of the rotation direction (the restriction of the relative rotation) between the reel and rotary shaft, the height-direction positioning of the reel, and the restriction of the inclination of the reel with respect to the surface perpendicular to the rotation axis are all carried out only by the mutual meshing engagement between the drive gear 61 and reel gear 63 of the rotation drive unit 59. That is, these functions are fulfilled in a composite manner by a single part (gear). For this purpose, an extremely high degree of precision is required of the gear teeth in shape, position and variations between teeth; for example, in case where one gear tooth is damaged, the damaged gear tooth has an ill effect on all of the above functions and thus it is difficult to realize highly reliable rotation drive. Also, since the plurality of functions are fulfilled in an integral manner by a single part, the structure is complicated and an advanced technology is required, which makes it difficult to manufacture such structure and thus results in the high manufacturing cost of the structure. Further, this raises another drawback that high rotation accuracy is difficult to obtain.

### SUMMARY OF THE INVENTION

The present invention aims at eliminating the above drawbacks found in the magnetic tape reel chucking structure in the related art. Accordingly, it is an object of the invention to provide a reel and a reel chucking structure which can realize highly reliable rotation drive, can be manufactured with high precision and at a low cost, and can enhance the rotation accuracy of the reel.

In attaining the above object, according to a first aspect of the invention, there is provided a reel comprising a hub for winding a tape thereon and a rotation drive transmission formed at the end of the hub, the rotation drive transmission being disposed on a plane extending substantially perpendicularly to a rotation axis, wherein the rotation drive transmission includes a centering unit for making the rotation axis of the hub coincide with the rotation axis of a spindle; and a rotation direction securing unit for securing the spindle and the tape reel in the rotation direction thereof, and wherein the centering unit and the rotation direction securing unit are disposed at different positions in the plane independently of each other.

According to the reel, since the centering unit and the rotation direction securing unit are disposed at different positions in the same plane independently of each other, even in case where one of the centering unit and rotation direction securing unit is damaged, for example, one of them is dented or deformed, the other, which is not damaged, can be kept free from the influence of the damaged one. Therefore, when compared with the structure in the related art which fulfills these functions in a composite manner in one portion thereof, the present reel can realize highly reliable rotation drive. Also, the shapes of the present centering unit and rotation direction securing unit are simple when compared with the structure in the related art in which a plurality of functions are integrated into one portion thereof and are fulfilled there, thereby being able to facilitate the machining of them, which makes it possible to manufacture them with high precision and at low costs. Further, because the centering unit and rotation direction securing unit can be produced with high precision, the rotation accuracy of the reel can also be enhanced.

Also, the above reel may further comprise a receiving surface formed in the plane of the reel which restricts the height position of the reel along the direction of the rotation axis and the inclination of the reel with respect to the plane of the reel to thereby position the reel.

According to the present reel, in case where the plane of the spindle approaches the plane of the reel, the plane of the spindle is contacted with the receiving surface formed in the plane of the reel. The receiving surface is formed as a reference surface which can restrict the height position of the reel along the rotation axis direction thereof and the inclination of the reel with respect to the plane thereof. Therefore, when the plane of the spindle is contacted with the receiving surface, the position of the reel along the rotation axis direction and the inclination of the reel with respect to the plane are restricted: that is, the reel can be positioned in this manner.

In attaining the above object, according to a second aspect of the invention, there is provided a reel chucking structure comprising a rotation drive transmission part for transmission of rotation drive between a reel for winding a tape thereon and a spindle for driving and rotating the reel, the rotation drive transmission part being disposed on a plane extending substantially perpendicularly to a rotation axis, wherein a centering unit for making the rotation axis of the reel coincide with the rotation axis of the spindle and a rotation direction securing unit for securing the spindle and the reel in the rotation direction thereof are disposed at different positions in the plane independently of each other.

According to the reel chucking structure, since the centering unit and the rotation direction securing unit are disposed at different positions in the same plane independently of each other, even in case where one of the centering unit and rotation direction securing unit is damaged, for example, one of them is dented or deformed, the other, which is not damaged, can be kept free from the influence of the damaged one. Therefore, when compared with the structure in the related art which fulfills these functions in a composite manner in one portion thereof, the present chucking structure can realize highly reliable rotation drive. Also, the shapes of the present centering unit and rotation direction securing unit are simple when compared with the structure in the related art in which a plurality of functions are integrated into one portion thereof and are fulfilled there, thereby being able to facilitate the machining of them, which makes it possible to manufacture them with high precision and at low costs. Further, because the centering unit and rotation direction securing unit can be produced with high precision, the rotation accuracy of the reel can also be enhanced.

Also, in the above reel chucking structure, the centering unit may also comprise a recessed portion and a projecting portion respectively including a tapered surface or a spherical-shaped surface formed in the circumferential direction with the above-mentioned rotation axis as the center thereof.

According to the present reel chucking structure, in case where the plane of the spindle approaches the plane of the reel, the recessed portion and projecting portion are engaged with each other. And, since the recessed portion and projecting portion both include a tapered surface or a spherical-shaped surface formed concentrically with the rotation axis thereof, the rotation axes of the reel and spindle are allowed to coincide with each other.

Also, in the present reel chucking structure, in the plane of the reel, there may be formed a receiving surface which restricts the height position of the reel along the direction of the rotation axis and the inclination of the reel with respect to the plane of the reel to thereby position the reel.

According to the present reel chucking structure, in case where the plane of the spindle approaches the plane of the reel, the plane of the spindle is contacted with the receiving surface formed in the plane of the reel. The receiving surface is formed as a reference surface which can restrict the height position of the reel along the rotation axis direction thereof and the inclination of the reel with respect to the plane thereof. Therefore, when the plane of the spindle is contacted with the receiving surface, the position of the reel along the rotation axis direction and the inclination of the reel with respect to the plane are restricted: that is, the reel can be positioned in this manner.

The above-mentioned reel chucking structure may also be formed in such a manner that, in a state where the recessed portion and projecting portion are engaged with each other, there is formed a slight clearance between the tapered surface of the recessed portion and the tapered surface of the projecting portion.

According to the present reel chucking structure, when the recessed portion and projecting portion respectively including a tapered surface are engaged with each other, there is formed a slight clearance between the recessed portion and projecting portion, thereby being able to avoid the close fit of the recessed portion and projecting portion that can be caused by the close contact of their respective tapered surfaces.

In the above-mentioned reel chucking structure, the clearance between the two tapered surfaces, preferably, may be set in the range of 1 to 40 μm.

According to the present reel chucking structure, since the clearance between the two tapered surfaces is set in the range of 1 to 40 μm, not only there can be eliminated the close fit that can occur when the clearance is smaller than 1 μm but also there can be prevented the misalignment (the rickety motion) of the rotation axes of the reel and spindle that can occur when the clearance is larger than 40 μm.

Also, in the above-mentioned reel chucking structure, the rotation direction securing unit may comprise projections formed in one of the planes of the reel and spindle so as to extend along the circumferential direction with the rotation axis as the center thereof and recesses formed in the other of the planes of the reel and spindle, and each of the projections may be formed in a substantially semi-spherical shape, in a conical shape, or in a truncated cone shape.

According to the present reel chucking structure, since the rotation direction securing unit comprises the projections and recesses and each of the projections is formed in a substantially semi-spherical shape, in a conical shape, or in a truncated cone shape, the projection is formed in a tapered shape. Thanks to this, even before the centering unit makes the rotation axes of the reel and spindle coincide with each other (that is, even in a state where the rotation centers of the reel and spindle are out of alignment), there is generated room between the recess and the leading end of the projection to be inserted into the interior of the recess (that is, the projection and recess are loosely fitted with each other), thereby being able to prevent a collision between the projection and recess.

Also, in the above-mentioned reel chucking structure, the recess may have the shape of a locus obtained by stretching the projection in the radial direction with the rotation axis as the center thereof.

According to the present reel chucking structure, since the recess has the shape of a locus obtained by stretching the projection in the radial direction with the rotation axis as the center thereof, when the projection is engaged with the recess, there can be eliminated a restriction on the radial-direction positions of the projection and recess. This makes it possible to fulfill the centering effect of the centering unit smoothly.

Also, in the above-mentioned reel chucking structure, between the projection and recess, there may also be set a slight clearance which extends in the circumferential direction with the rotation axis as the center thereof.

According to the present reel chucking structure, when the projection and recess are engaged with each other, between the projection and recess, there is formed a slight clearance extending in the circumferential direction with the rotation axis as the center thereof, thereby being able to prevent the close fit of the projection and recess that can occur due to the close contact of the projection and recess.

Also, in the above-mentioned reel chucking structure, the clearance in the circumferential direction, preferably, may be set in the range of 10 to 100 μm.

According to the present reel chucking structure, because the clearance in the circumferential direction is set in the range of 10 to 100 μm, not only there can be prevented the close fit of the projection and recess that can occur when the clearance is smaller than 10 μm, but also there can be prevented the rickety motion of the projection and recess that can occur when the clearance is larger than 100 μm.

### BRIEF DESCRIPTION OF THE DRAWINGS

FIG. 1 is a longitudinal section view of the main portions of a reel in a chucking structure according to the invention;

FIG. 2 is a perspective view of the reel shown in FIG. 1, when it is viewed from the lower surface side thereof;

FIG. 3 is a perspective view of a spindle for driving and rotating the reel shown in FIG. 1; and

FIG. 4 is a longitudinal section view of a magnetic tape cartridge in the related art.

### DETAILED DESCRIPTION OF THE INVENTION

Now, description will be given below of a preferred embodiment of a reel chucking structure according to the invention in detail with reference to the accompanying drawings.

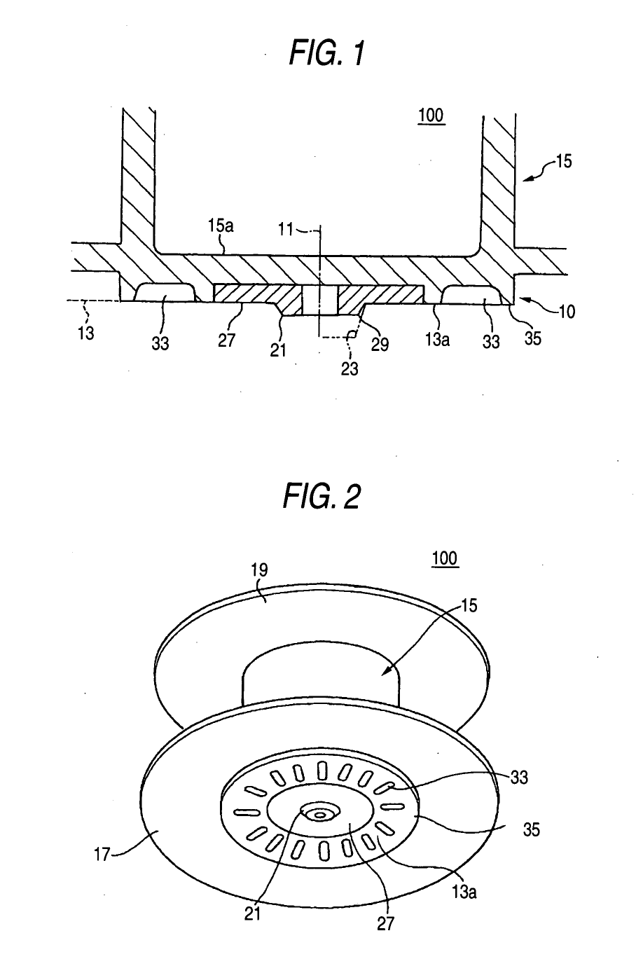

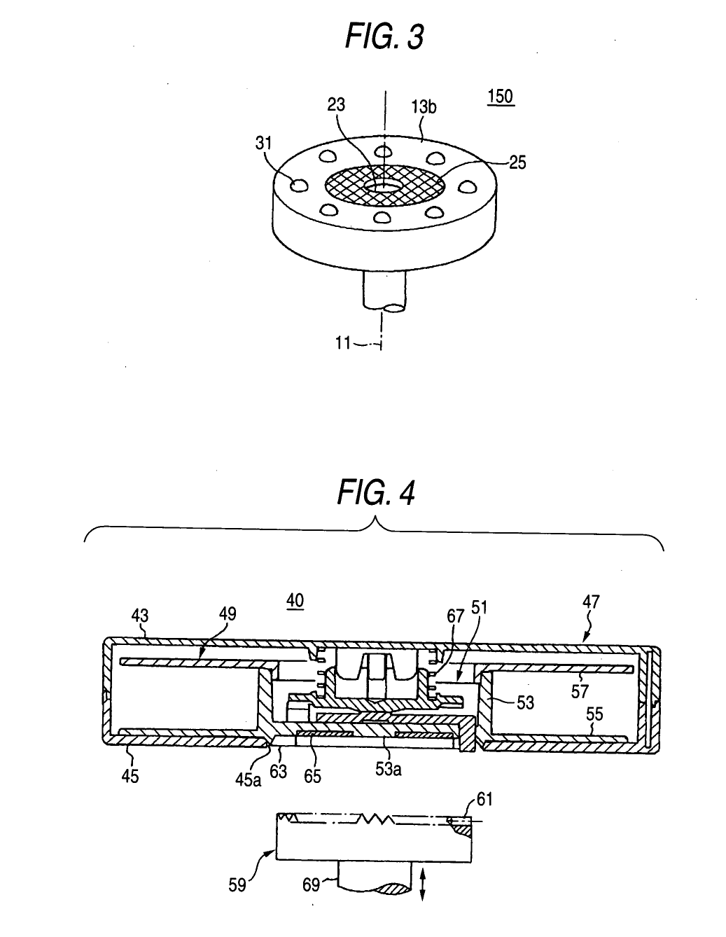

FIG. 1 is a longitudinal section view of the main portions of a reel of a chucking structure according to the invention, FIG. 2 is a perspective view of the reel shown in FIG. 1, when it is viewed from the lower surface side thereof, and FIG. 3 is a perspective view of a spindle which is used to drive and rotate the reel shown in FIG. 1.

As shown in FIGS. 1 to 3, in a reel chucking structure according to the present embodiment, a rotation drive transmission part 10 for transmission of rotation drive between a reel 100 for winding a magnetic tape thereon and a spindle 150 for driving and rotating the reel 100 is disposed on a plane 13 which extends-substantially perpendicularly to a rotation axis 11.

The reel 100, similarly to the chucking structure in the related art, is rotatably stored in a cartridge case. The cartridge case is composed of an upper case (not shown) and a lower case having an opening formed in the central portion thereof, with the upper and lower cases fastened together by a screw or the like. The reel 100 comprises a bottomed cylindrical-shaped hub 15 on the outer periphery of which a magnetic tape can be wound, and lower and upper flange portions 17 and 19 which respectively extend out in a disk manner in the radial direction of the hub 15 from the outer peripheries of the lower and upper end portions of the hub 15. The hub 15 and lower flange portion 17 are made of synthetic resin material as an integral body; and, the upper flange portion 19 is then connected to such integral body by ultrasonic welding or by similar unit.

The hub 15 is structured such that the center-side lower portion thereof is closed by a bottom wall 15a. On the lower surface of the bottom wall 15a (the plane 13a of the reel 100), there is disposed a projecting portion 21 having a tapered surface serving as centering unit in such a manner that it extends in the circumferential direction of the hub 15 coaxially with the rotation axis 11. On the other hand, in the upper surface of the spindle 150 (the plane 13b of the spindle 150), there is formed a recessed portion 23 having a tapered surface serving as centering unit in such a manner that it extends in the circumferential direction of the spindle 150 coaxially with the rotation axis 11. In case where these projecting portion 21 and recessed portion 23 are engaged with each other, the positions of the hub 15 and spindle 150 can be restricted (that is, the radial-direction positions of the hub 15 and spindle 150 can be restricted) so that the rotation axis 11 of the reel 100 can be made to coincide with the rotation axis 11 of the spindle 100.

That is, in case where the plane 13b of the spindle 150 approaches the plane 13a of the reel 100, the recessed portion 23 and projecting portion 21 are engaged with each other. And, since the recessed portion 23 and projecting portion 21 are both formed so as to have tapered shapes which are coaxial with the rotation axis 11, the rotation axes 11 of the reel 100 and spindle 150 can be made to coincide with each other. By the way, at least one of the recessed portion 23 and projecting portion 21 may also be formed so as to have a spherical shape.

Also, the plane 13a of the reel 100 is contacted with the plane 13b of the spindle 150 as the spindle 150 is moved upwardly, so that the two planes 13a and 13b are united together as an integral body to thereby provide the plane 13. On the plane 13b of the spindle 150, there is disposed a magnet 25: that is, this magnet 25 attracts a reel plate 27 made of a metal plate with the projecting portion 21 formed thereon, thereby being able to maintain the mutual engagement between the projecting portion 21 and recessed portion 23.

Here, between the tapered surface of the recessed portion 23 and the tapered surface of the projecting portion 21, there is formed a small clearance 29; and, therefore, when the recessed portion 23 and projecting portion 21 are engaged with each other, between the recessed portion 23 and projecting portion 21, there is interposed this clearance 29, thereby being able to avoid the close fit of the recessed portion 23 and projecting portion 21 that can occur due to the close contact between the two tapered surfaces. Preferably, the clearance 29 may be set in the range of 1 to 40 μm. Specifically, in case where the clearance 29 is set in the range of 1 to 40 μm, it is possible to prevent such close fit of the projecting and recessed portions that can occur when the clearance 29 is smaller than 1 μm and also it is possible to prevent the rotation axes 11 of the reel 100 and spindle 150 from shifting from each other (that is, it is possible to prevent the occurrence of rickety motion between the reel 100 and spindle 150) which can occur when the clearance 29 is larger than 40 μm.

On the plane 13b of the spindle 150, more specifically, on the periphery of the recessed portion 23, there are disposed a plurality of projections 31 serving as rotation direction securing unit in such a manner that they are situated in the circumferential direction of the plane 13b with the rotation axis 11 as the center thereof. Each of the projections 31 may be preferably formed in a substantially semi-spherical shape, in a conical shape or in a truncated cone shape. In the present embodiment, description will be given of a case in which the projection 31 is formed so as to have a substantially semi-spherical shape.

Also, in the plane 13a of the reel 100, more specifically, in the periphery of the projecting portion 21, there are formed a plurality of recesses 33 serving as rotation direction securing unit in such a manner that they are situated in the circumferential direction of the plane 13a with the rotation axis 11 as the center thereof. Each of the recesses 33 has the shape of a locus which can be obtained by stretching the projection 31 having a substantially semi-spherical shape, a conical shape or a truncated cone shape in the radial direction of the plane 13a. In the present embodiment, the recess 33 has a shape having an elliptical-shaped locus which can be obtained by stretching the substantially semi-spherical-shaped projection 31 in the radial direction.

Since the projection 31 serving as the rotation direction securing unit is formed in a substantially semi-spherical shape, in a conical shape, or in a truncated cone shape, the projection 31 has a tapered shape; and, therefore, even before the centering unit makes the rotation axis 11 of the reel 100 and the rotation axis 11 of the spindle 150 coincide with each other (that is, even when the rotation centers of the reel 100 and spindle 150 are out of alignment), there is generated room between the recess 33 and projection 31 to be inserted into the interior of the recess 33 (that is, the recess 33 and projection 31 are loosely fitted with each other), thereby avoiding a collision between the projection 31 and recess 33. On the other hand, after they are centered, the projection 31 and recess 33 are engaged with each other.

Also, because the recess 33 has the shape of a locus which can be obtained by stretching the projection 31 in the radial direction, when the projection 31 is engaged with the recess 33, there can be eliminated restrictions on the radial-direction positions of the projection 31 and recess 33. This makes it possible to fulfill the centering effect of the centering unit smoothly.

Further, between the projection 31 and recess 33, there is disposed a slight clearance which extends in the circumferential direction with the rotation axis 11 as the center thereof. Due to this, when the projection 31 and recess 33 are engaged with each other, between the projection 31 and recess 33, there is interposed a slight clearance extending in the circumferential direction with the rotation axis 11 as the center thereof, thereby being able to prevent their mutual close fit which can occur when the projection 31 and recess 33 are closely contacted with each other.

The clearance between the projection 31 and recess 33, preferably, may be set in the range of 10 to 100 μm. This not only can prevent the close fit of the projection 31 and recess 33 which can occur when the clearance is smaller than 10 μm, but also can prevent the rickety motion between the projection 31 and recess 33 which can be caused when the clearance is larger than 100 μm.

As described above, the projecting portion 21 and recessed portion 23 serving as the centering unit, and the projections 31 and recesses 33 serving as the rotation direction securing unit are disposed at different positions of the plane 13 independently of each other.

Also, in the plane 13a of the reel 100, there is formed a receiving surface 35 which restricts the position of the reel 100 in the direction along the rotation axis 11 of the reel 100 and the inclination of the reel 100 with respect to the plane 13 to thereby position the reel 100. Therefore, in case where the plane 13b of the spindle 150 approaches the plane 13a of the reel 100, the plane 13b of the spindle 150 is contacted with the receiving surface 35 of the reel 100. The receiving surface 35 is formed as a reference surface which restricts the rotation-axis-11-direction position of the reel 100 and the inclination of the reel 100 with respect to the plane 13. Due to this, when the plane 13b of the spindle 150 is contacted with the receiving surface 35 of the reel 100, the rotation-axis-11-direction position of the reel 100 and the inclination of the reel 100 with respect to the plane 13 are restricted, so that the reel 100 can be positioned.

The projecting portion 21 and recessed portion 23 serving as the centering unit, the projections 31 and recesses 33 serving as the rotation direction securing unit, and the receiving surface 35 cooperate together in constituting the above-mentioned rotation drive transmission part 10.

According to the thus-constituted reel chucking structure, since the centering unit (projecting portion 21, recessed portion 23) and the rotation direction securing unit (projections 31, recesses 33) are disposed at different positions in the plane 13 in such a manner that the two unit are independent of each other, even in case where one of the centering unit and rotation direction securing unit is damaged, for example, one of them is dented or deformed, the other, which is not damaged, can be kept free from the influence of the damaged one. Therefore, when compared with the structure in the related art which fulfills these functions in a composite manner in one portion thereof, the present chucking structure can realize highly reliable rotation drive. Also, the shapes of the present centering unit and rotation direction securing unit are simple when compared with the structure in the related art in which a plurality of functions are integrated into one portion thereof and are fulfilled there, thereby being able to facilitate the machining of them, which makes it possible to manufacture them with high precision and at low costs. Since the centering unit and rotation direction securing unit can be produced with high precision, the rotation accuracy of the reel 100 can also be enhanced.

By the way, in the above embodiment, description has been given of an example in which the projecting portion 21 is formed in the plane 13a of the reel 100 and the recessed portion 23 is formed in the plane 13b of the spindle 150. However, a reel chucking structure according to the invention may also be a structure in which, reversely to the above embodiment, the projecting portion 21 is formed in the plane 13b of the spindle 150 and the recessed portion 23 is formed in the plane 13a of the reel 100.

Also, in the above embodiment, description has been given of an example in which the recesses 33 are formed in the plane 13a of the reel 100 and the projections 31 are disposed on the plane 13b of the spindle 150. However, a reel chucking structure according to the invention may also be a structure in which, reversely to the above embodiment, the recesses 33 are formed in the plane 13b of the spindle 150 and the projections 31 are disposed on the plane 13a of the reel 100.

Further, in the above embodiment, description has been given of a case in which the chucking structure of a magnetic tape reel is applied to a cartridge of a one-reel type, for example, a DLT (Digital Linear Tape) cartridge or an LTO (Linear Tape-Open) cartridge in which projectingly and recessedly shaped gears are formed on a plane perpendicular to a rotation axis. However, the invention can also be applied to a reel including a chucking structure in which, as in a cartridge of a two-reel type (such as an audio cassette or a video cassette), projections and recesses are disposed in the radial direction of a rotation axis. In this case as well, there can be provided similar operations and effects to the above embodiment.

According to a reel and a reel chucking structure of the invention, since the centering unit for making the rotation axis of the reel coincide with the rotation unit of the spindle and the rotation direction securing unit for restricting the relative rotation between the spindle and reel are disposed at different positions in a plane independently of each other, even in case where one of the centering unit and rotation direction securing unit is damaged, the other can be kept free from the influence of such damage, thereby being able to realize highly reliable rotation drive. Also, the centering unit and rotation direction securing unit are simplified in shape; and, therefore, it is easy to machine the centering unit and rotation direction securing unit, so that the centering unit and rotation direction securing unit can be manufactured with high precision and at low costs. Further, because the centering unit and rotation direction securing unit can be formed with high precision, the rotation accuracy of the reel can also be enhanced.

The entire disclosure of each and every foreign patent application from which the benefit of foreign priority has been claimed in the present application is incorporated herein by reference, as if fully set forth.

What is claimed is:

1. A reel comprising:
a hub for winding a tape thereon; and
a rotation drive transmission formed at the end of the hub, the rotation drive transmission being disposed on a plane extending substantially perpendicularly to a rotation axis,
wherein the rotation drive transmission includes:
a centering unit for making the rotation axis of the hub coincide with the rotation axis of a spindle; and
a rotation direction securing unit for securing the spindle and the tape reel in the rotation direction thereof,
and wherein the centering unit and the rotation direction securing unit are disposed at different positions in the plane independently of each other.

2. The reel as claimed in claim 1, further comprising:
a receiving surface formed in the plane of the reel which restricts the height position of the reel along the direction of the rotation axis and the inclination of the reel with respect to the plane of the reel to thereby position the reel.

3. A reel chucking structure comprising:
a rotation drive transmission part for transmission of rotation drive between a reel for winding a tape thereon and a spindle for driving and rotating the reel, the rotation drive transmission part being disposed on a plane extending substantially perpendicularly to a rotation axis,
wherein a centering unit for making the rotation axis of the reel coincide with the rotation axis of the spindle and a rotation direction securing unit for securing the spindle and the reel in the rotation direction thereof are disposed at different positions in the plane independently of each other.

4. The reel chucking structure as claimed in claim 3, wherein the centering unit comprises a recessed portion and a projecting portion respectively including a tapered surface or a spherical-shaped surface formed in the circumferential direction with the rotation axis as the center thereof.

5. The reel chucking structure as claimed in claim 3, further comprising:
a receiving surface formed in the plane of the reel which restricts the height position of the reel along the direction of the rotation axis and the inclination of the reel with respect to the plane of the reel to thereby position the reel.

6. The reel chucking structure as claimed in claim 4, wherein the reel chucking structure is formed in such a manner that, in a state where the recessed portion and projecting portion are engaged with each other, there is formed a clearance being set in the range of 1 to 40 μm between the tapered surface of the recessed portion and the tapered surface of the projecting portion.

7. The reel chucking structure as claimed in claim 3, wherein the rotation direction securing unit comprises a projection formed in one of the planes of the reel and spindle so as to extend along the circumferential direction with the rotation axis as the center thereof and a recess formed in the other of the planes of the reel and spindle, and the projection is formed in a substantially semi-spherical shape, in a conical shape, or in a truncated cone shape.

8. The reel chucking structure as claimed in claim 7, wherein the recess has the shape of a locus obtained by stretching the projection in the radial direction with the rotation axis as the center thereof.

9. The reel chucking structure as claimed in claim 7, wherein, between the projection and recess, there is set a clearance being set in the range of 10 to 100 μm which extends in the circumferential direction with the rotation axis as the center thereof.
